(19) United States
(12) Patent Application Publication
(10) Pub. No.: US 2013/0073378 A1
(43) Pub. Date: Mar. 21, 2013

(54) SOCIAL MEDIA CAMPAIGN METRICS

(71) Applicants: Eyal Naveh, Ramat Gan (IL); Roy Varshavsky, Even Yehuda (IL); Ron Karidi, Herzeliya (IL); Adi Diamant, Shoham (IL); Eugene (John) NEYSTADT, Kfar-Saba (IL)

(72) Inventors: Eyal Naveh, Ramat Gan (IL); Roy Varshavsky, Even Yehuda (IL); Ron Karidi, Herzeliya (IL); Adi Diamant, Shoham (IL); Eugene (John) NEYSTADT, Kfar-Saba (IL)

(73) Assignee: MICROSOFT CORPORATION, Redmond, WA (US)

(21) Appl. No.: 13/235,500

(22) Filed: Sep. 19, 2011

(51) Int. Cl. G06Q 30/00; G06F 15/16

(52) U.S. Cl. 705/14.41; 709/204

(57) ABSTRACT

A social marketing system may measure the performance of marketing campaigns using the effective click through rates that include impressions that are due to propagation of items through social networks. A social marketing system may track an initial effectiveness in starting a campaign, as well as track the propagation of the campaign information through multiple social networks. The effectiveness of the campaign may be measured using the effective click through rates for various target audiences. The social marketing system may create links to advertising materials and thereby track interactions when users click through the links to interact with the materials. The effectiveness of the social media campaign may be based in part by measuring the actual or estimated number of impressions through social media networks.

### BACKGROUND

Advertising metrics for conventional online advertising campaigns are used to measure the effectiveness of the campaign. In many cases, these metrics may be used to validate advertising assumptions, determine payments for campaigns, and rate one campaign against another.

Social media include systems where users may share information with other users, including recommendations for products or services. Many items may be propagated virally through social networks, where one person recommends something to a group of people, who then go on to recommend to a larger group of people. In such cases, information may be spread without engaging common news media or other distribution outlets.

### SUMMARY

A social marketing system may measure the performance of marketing campaigns using the effective click through rates that include impressions that are due to propagation of items through social networks. A social marketing system may track an initial effectiveness in starting a campaign, as well as track the propagation of the campaign information through multiple social networks. The effectiveness of the campaign may be measured using the effective click through rates for various target audiences. The social marketing system may create links to advertising materials and thereby track interactions when users click through the links to interact with the materials. The effectiveness of the social media campaign may be based in part by measuring the actual or estimated number of impressions through social media networks.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a network environment with a social marketing system.

FIG. 2 is a flowchart, of an embodiment showing a method for launching a social marketing campaign.

FIG. 3 is a flowchart, of an embodiment showing a method for monitoring campaign effectiveness.

### DETAILED DESCRIPTION

Online social marketing can involve a complex set of interactions that are tracked and analyzed to identify statistics for a marketing campaign, as well as identify those people whose actions influence a campaign. The interactions may be gathered from one or more social networks and may reflect multiple ways users may interact.

The statistics may include identifying the number of unique users, sessions, recommenders, actual recommendations made, and comparisons between social networks.

The operations of online social marketing are more complex than conventional online marketing because online social marketing may encourage and measure interactions between users over the course of a campaign. An online social marketing campaign may attempt to cause campaign information to spread from person to person, though their online social interactions. Online social marketing campaigns may operate under the premise that a recommendation from a trusted friend, relative, or person may be much more effective than conventional email or web-based advertisements. In many cases, an online social marketing campaign may use a combination of conventional online advertisements with social networking to deliver a complete advertisement campaign.

In some cases, the social network may be an express social network where users have actively identified a one way or two way relationship with other users. In other cases, the social network may be a loose or implied social network where users develop one way or two way relationships with other users through implied mechanisms.

For the purposes of this specification and claims, the term “social network” or “online social network” may relate to any type of computerized mechanism through which persons may connect or communicate with each other. Some social networks may be applications that facilitate end-to-end communications between users in a formal social network. Other social networks may be less formal, and may consist of a user's email contact list, phone list, mailing list, or other database from which a user may initiate or receive communication.

In some cases, a social network may facilitate one-way relationships. In such a social network, a first user may establish a relationship with a second user without having the second user's permission or even making the second person aware of the relationship. A simple example may be an email contact list where a user may store contact information for another user. Another example may be a social network where a first user “follows” a second user to receive content from the second user. The second user may or may not be made aware of the relationship. A third example may be a web log where a first person may publish postings that are read by a second person.

In some cases, a social network may facilitate two-way relationships. In such a social network, a first user may request a relationship with a second user and the second user may approve or acknowledge the relationship so that the two-way relationship may be established. In some social networks, each relationship within the social network may be a two-way relationship. Some social networks may support both one-way and two-way relationships.

For the purposes of this specification and claims, the term “person” or “user” may refer to both natural people and other entities that operate as a “person”. A non-natural person may be a corporation, organization, enterprise, team, or other group of people.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

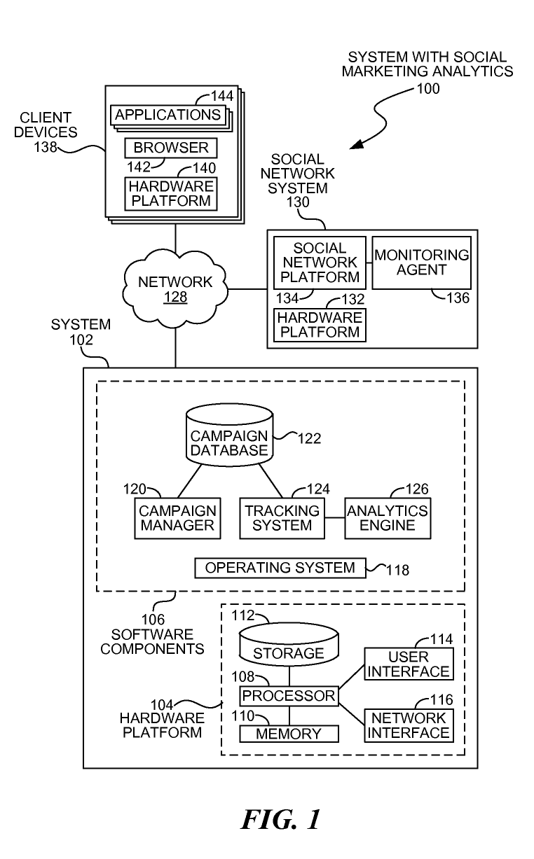

FIG. 1 is a diagram of an embodiment 100, showing a system 102 that may provide tracking and analytics for an online social marketing campaign. Embodiment 100 is a simplified example of a network ecosystem in which social marketing campaigns may be managed, tracked, and analyzed.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 shows a network environment in which an online social marketing campaign may be implemented, tracked, and analyzed. In order to quantify the effectiveness of a particular campaign, as well as compare one campaign to another, a set of statistics may be measured or estimated to determine the number of impressions a campaign has had, the number of actions taken by users based on those impressions, and the influence of certain users with respect to the campaign.

The statistics may identify those users who exert influence in the social networks. Many users have a passive role in today's online social networks, where they tend to consume information but add very little to the conversation. Other users may be more active and communicate using the social networks more often. The statistics may be used to identify and quantity those people who influence others in a marketing campaign.

A social marketing campaign may operate by sending several influential people a set of campaign materials that include a traceable object. The influential people, known as influencers, may spread the word about the campaign through various social network communications, and the traceable object may be monitored when the item may be passed from one person to another. The traceable item may be tracked when people perform some action relating to the campaign, such as purchasing a product, joining a group, making a contribution, or performing some other action. In some cases, the system may be able to reward the influencers by financial or reputation mechanisms.

The social marketing system of embodiment 100 may operate with two groups of people. A marketing professional may create and manage the campaigns while one or more influencers may actually implement the campaigns. The marketing professional may select a set of influencers and offer an opportunity to the influencers to join the campaign. After the influencers accept the invitation, the influencers may receive various campaign materials, which may include product samples, brochures, reference materials, and in some cases upfront compensation. The marketing professional may use the metrics and statistics generated by the system to track users and, in some cases, reward users.

The influencers may spread the word about the campaign by contacting other people indirectly or directly. For example, an indirect form of contact may be to publish a weblog posting that relates to the campaign. An example of a direct form of contact may be to email information to people within the influencer's social network.

As part of the campaign, the influencer may transmit a traceable object, which may be a redeemable coupon, link to a website, or other item. The traceable object may be received by a user. In many campaigns, the user may perform some function, such as purchasing a product or performing some other action.

The types of campaigns may be any type of campaign that may have a call to action. In a retail marketing example, the campaign may entice people to purchase a specific item or to visit a specific retail outlet. In a non-profit giving campaign example, users may be enticed to donate money, items, or time to a specific organization. In a political campaign example, users may be called to become active on behalf of a candidate or political cause, such as by donating money, attending a rally, joining a movement, or some other action,

The statistics tracked during a campaign may attempt to estimate a user's influence on other users. The amount of influence may be determined by the actual or estimated number of impressions generated by the user, along with an influence that may be calculated from each call to action performed by a user who received an impression.

The amount of influence may be attributed to a user may be discounted for each successive level of communication. For example, a user who directly influences a second user to purchase a product may get full ‘credit’ for the influence when there is direct communication from the first user to the second user. The user may be awarded some influence when the second user recommends the product to a third user, and somewhat less influence when the third user recommends the product to a fourth user, and so on.

Each level of recommendation or link in the recommendation stream may be used to attribute some level of influence to each person who participated in the sequence of recommendations. In one embodiment, the first level recommender may be given a score of 1, a second level recommender may be given a score of X, a third level recommender may be given a score of X̂2, etc. The value of X may be 0.5, 0.75, or some other value, for example.

In a long sequence of recommenders, each person along the chain of recommendations may be given some influence score, as each person may contribute to the eventual sale of a product or other action.

In some formal online social networks, a tracking system may be capable of identifying each and every impression, communication, or other interaction between users. Within such social networks, some of the statistics relating to a marketing campaign may be easily identified.

In many social networks, there may be limited access to some of the data that may be collected. For example, an online social network may provide the number of contacts, friends, or other relationships for a specific user, but may not provide how many times a user's posting was shown to other users.

In another example, a user may communicate with their contact via electronic mail, instant messaging, or other mechanism that may be outside a formal online social network. Such communications may relate to an informal social network for which few data collection mechanisms may be available.

During the operation of a campaign, a tracking system may collect information such as the number of unique users, number of sessions established with a social marketing manager, number of recommenders, number of recommendations, potential number of impressions, and the total number of users completing a purchase or the call to action.

The number of unique users may be collected by identifying the users that interact with a traceable object. The number of unique users may reflect the penetration or coverage of the campaign on society as a whole or within a targeted audience.

As users interact with a traceable object, the users may be brought to a campaign website or other campaign related materials. These interactions may represent potential sales opportunities where the user has expressed at least some interest in the product. The system may be able to identify sessions with campaign materials where the sessions were started from a social network post.

As users interact with a marketing campaign, a tracking system may attempt to measure or estimate the number of impressions made for the campaign, as well as identify the interactions through which campaign information may he passed from one user to another.

One embodiment may estimate the number of impressions by using the total number of contacts for a user in a social network. When a user places a message in a social network that relates to a marketing campaign, the number of impressions may be estimated as the number of contacts for the user. In some embodiments, the number of impressions may be a function of the number of contacts, which may account for some users who may not access the social network or for whom the user's communication may not have been shown.

The function may merely discount the number of impressions by a predefined factor, such as calculating the number of impressions as 0.5 times the number of contacts, for example. Other embodiments may have other mechanisms for estimating the number of impressions.

A tracking system may collect data from multiple social networks, including formal and informal social networks. The tracking system may aggregate the statistics together for a global view of the campaign, as well as present separate statistics for each social network.

A social marketing system may have a measurement widget or monitoring agent that may identify communications on a social network that relate to a campaign. The monitoring agent may transmit identifiers for campaign materials whenever those materials are processed by the social network. Examples may include each time the campaign materials may be passed from one user to another, each time the materials may be viewed, or other interactions.

The monitoring agent may be able to detect operations that occur via direct electronic mail, where an electronic mail advertisement is sent directly to the user. A statistic for direct electronic mail may be the number of clicks on links in an electronic mail message divided by the number of electronic mail messages sent. The number of electronic mail messages sent may represent the number of impressions.

In a display advertisement, the monitoring agent may use tracking pixels or other mechanisms to determine when an advertisement was served as well as determine when the advertisement was clicked through. A representative statistic may be created by dividing the number of click throughs by the number of advertisements served.

In a search system, the monitoring agent may track the number of search results that a search engine displayed for campaign related materials. A representative statistic may be the number of clicks on the search result divided by the number of times the search result was presented on a display.

Some embodiments may define a statistic for weblogs or other places where an expert may share their insights and knowledge. In a marketing campaign, the expert may provide a link to a campaign from their weblog, for example, and users may follow the link or recommend it to other users. A statistic for such a campaign may have the number of clicks on the links divided by the number of viewers of the weblog or number of visitors to the expert website.

Some summary statistics may aggregate the interactions of each of the various social networking channels. For example, a summary statistic may include the total number of click throughs divided by the total number of impressions through the various channels. Another summary statistic may involve merely the total number of people exposed to the campaign through the various channels.

Each of the statistics above may be calculated for the number of actions taken by users in place of the number of click throughs.

In some embodiments, the number of impressions may be determined by an effective number of impressions, or the estimated number of impressions based on the user's relationships within the various social network. For example, a statistic may be generated from an effective number of impressions derived from each user's number of relationships within a social network. The effective number of impressions may be a discounted number from each user's total number of relationships.

In some embodiments, the statistics may be further determined by using a number of effective impressions based on a set of effective impressions per a given demographic. For example, a statistic may be generated from the number of clicks for a certain category of users, such as females between the ages of 25 and 35.

The statistics may be gathered to compare the effectiveness of various mechanisms for seeding the campaign. For example, statistics for electronic mail may be compared to statistics for online advertisements, expert reviews, and influencer recommendations. Such statistics may be used to change a campaign while the campaign is underway, such as increasing a seeding mechanism that is proving to be effective, while limiting investment in those mechanisms that are not producing.

In some embodiments, a tracking system may be able to identify users who may be exposed to several different forms of the advertising campaign. For example, a statistic may identify a click through rate for those users who received an email impression first, then a recommendation from an influential person. Such combinations of campaign mechanisms may be identified to identify an effective sequence of deployment. In such embodiments, an optimized campaign may involve seeding using electronic mail, for example, then later following up through expert recommendations.

Some embodiments may identify those users who may have a high degree of influence over other users. Such influencers may be identified for future marketing campaigns. In some embodiments, influencers may be identified during a campaign and given additional opportunities to participate.

In some cases, the statistics may be used as part of a contract or compensation system for social marketing companies. A social marketing company may guarantee a specific number of impressions or a click through rate to their clients, who may be a product manufacturer, retailer, or other party. In some cases, a social marketing company may be paid based on meeting or exceeding a statistical condition, or using some formula that uses one or more of the statistics as a parameter.

Embodiment 100 is illustrated as having a system 102 that may perform simulations along with managing social marketing campaigns. The system 102 may have a hardware platform 104 and software components 106.

The system 102 may represent a server or other powerful, dedicated computer system that may support multiple user sessions. In some embodiments, however, the system 102 may be any type of computing device, such as a personal computer, game console, cellular telephone, netbook computer, or other computing device.

The hardware platform 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware platform 104 may include user interface devices 114. The user interface devices 114 may include keyboards, monitors, pointing devices, and other user interface components.

The hardware platform 104 may also include a network interface 116. The network interface 116 may include hardwired and wireless interfaces through which the system 102 may communicate with other devices.

Many embodiments may implement the various software components using a hardware platform that is a cloud fabric. A cloud hardware fabric may execute software on multiple devices using various virtualization techniques. The cloud fabric may include hardware and software components that may operate multiple instances of an application or process in parallel. Such embodiments may have scalable throughput by implementing multiple parallel processes.

The software components 106 may include an operating system 118 on which various applications may execute. In some cloud based embodiments, the notion of an operating system 118 may or may not be exposed to an application.

The system may have a campaign manager 120 that may be used to create and manage social marketing campaigns. The campaign manager 120 may manage a website or series of websites that contain campaign materials, as well as systems that may create traceable items that may be passed from user to user.

The campaign manager 120 may use a campaign database 122 that may contain campaign materials as well as a database of users. The campaign manager 120 may identify those users who may be influencers and may contact the influencers to seed the campaign. In some cases, the campaign manager 120 may offer financial or non-financial incentives for the participants of the campaign.

A tracking system 124 may track as many interactions and operations of the campaign as possible. In some embodiments, the tracking system 124 may operate with a deep level of integration into an online social network 130. In such embodiments, the tracking system 124 may have a monitoring agent 136 that may be coupled with a social network platform 134 operating on a hardware platform 132. The monitoring agent 136 may be capable of tracking communications between users where campaign materials were transmitted, as well as impressions of campaign materials when users post information.

In some cases, the tracking system 124 may not be able to gather detailed data from the social network platform 134. In such cases, the tracking system 124 may estimate some of the statistics based on available data.

The tracking system 124 may track data from many different social networks. Some social networks may be so-called microblogging sites where users may share short messages in a public forum. Other social networks may be formal social networks were two-way relationships are made prior to establishing a formal relationship. Still other social networks may be informal social networks where users communicate via electronic mail, instant messaging, weblog posts or comments, or other communications.

An analytics engine 126 may analyze the data collected by the tracking system 124. The analytics engine 126 may generate summary and detailed statistics. In some embodiments, the analytics engine 126 may be accessible by a campaign administrator via a website where various statistics may be presented.

The system 102 may be connected to the social network systems 130 and client device 138 by a network 128. Various client devices 138 may have a hardware platform 140 on which a browser 142 or dedicated applications 144 may interact with the social networks.

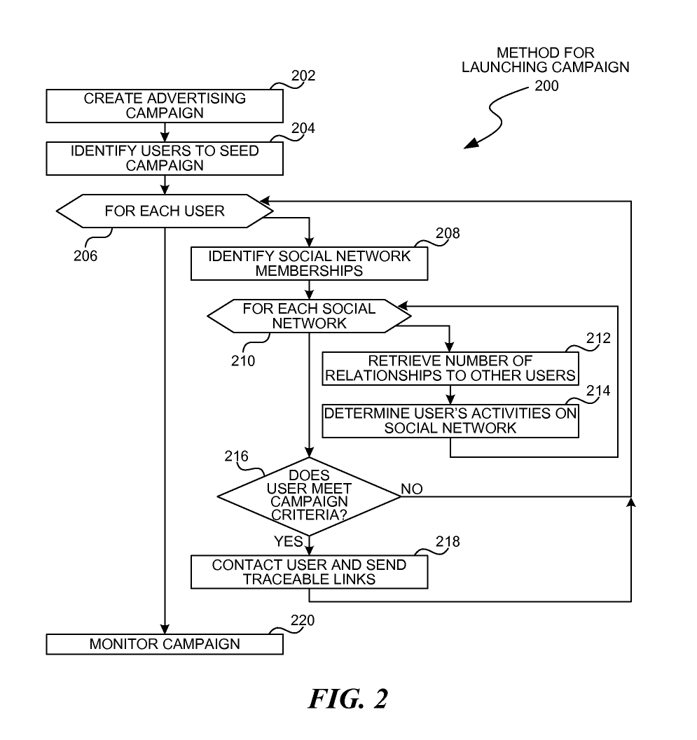

FIG. 2 is a flowchart illustration of an embodiment 200 showing a method for launching a social marketing campaign. Embodiment 200 is a simplified example of a method that may be performed using a campaign manager to create and seed a social marketing campaign.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

An advertising campaign may be created in block 202. The campaign may include campaign materials, such as websites, links, brochures, or other items, including traceable items that may be used by a tracking system to identify interactions with the campaign.

The campaign may also include a campaign sequence. The campaign sequence may include several steps that may be timed to occur on specific days or in a specific sequence. For example, the campaign sequence may include sending out teaser information to the general public, followed by sample products to certain influencers, followed by discount coupons for other influencers, and so forth. The sequence may be defined to perform certain steps on predefined days, or may be defined to launch a step when certain conditions are met.

In block 204, users that may seed the campaign may be identified.

For each user in block 206, the user's social network memberships may be identified in block 208. For each of the user's social networks in block 210, the number of relationships in the social network may be retrieved. In block 214, the user's activity within the social network may be measured or estimated.

The user's activity plus the size of the user's social network may be evaluated in block 216 to see whether the user meets campaign criteria for seeding the campaign. If not, the process may return to block 206 to evaluate another user. If so, the user may be contacted in block 218 and given a traceable item to participate in the campaign.

After seeding all of the users in the campaign, the process may start monitoring the campaign in block 220.

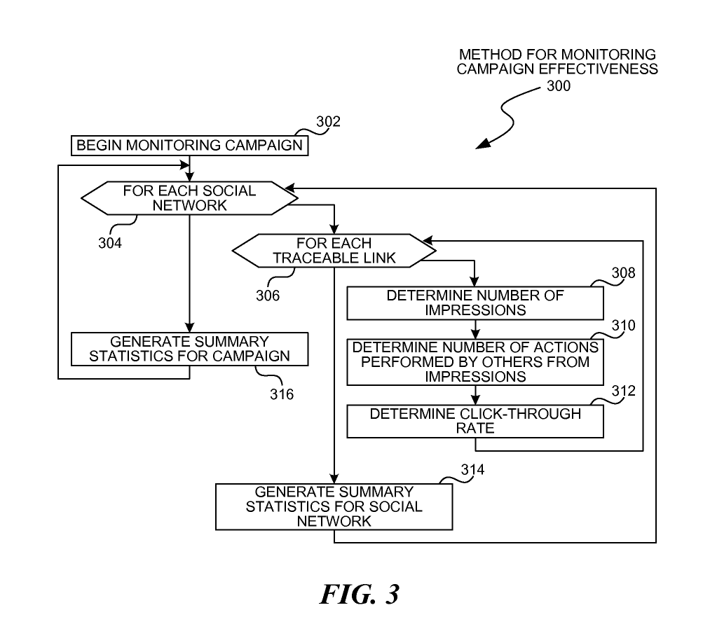

FIG. 3 is a flowchart illustration of an embodiment 300 showing a method for monitoring a social marketing campaign. Embodiment 300 is a simplified example of a method that may be performed to collect and summarize statistics for a social marketing campaign.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The campaign monitoring may begin in block 302.

Each social network may be analyzed in block 304. In some cases, the social network may be a formal social network while other cases the social network may be informal. Each social network may have different types of data collection mechanisms.

Within a social network, each traceable link that may have passed within that social network may be analyzed in block 306. The traceable link may be analyzed by determining a number of impressions in block 308, determining a number of actions performed by others based on the impressions in block 310, and determining a click through rate in block 312.

In some social networks some or all of the statistics in blocks 308 through 312 may be determined by directly querying the social network system. In other social networks, the same statistics may be estimated by various mechanisms, as described above.

A set of summary statistics may be generated in block 314 for the social network being analyzed. After analyzing all of the social networks in block 304, a set of summary statistics may be generated in block 316 for the campaign.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a campaign manager operating on at least one processor that:
generates a campaign information comprising a first link, said first link causing said campaign manager to receive at least some communication;
transmits said campaign information to a plurality of users; detects that at least a portion of said campaign information was used in a first social network as a first social network post by a first user; and
creates a second campaign information for said first social network post, said second campaign information having a second link, said second link causing said campaign manager to receive at least some communication;
a tracking system that:
detects when a link to said campaign information is clicked;
creates a record comprising an identifier for a person clicking on said link; and
stores said record in an analytics database;
an analytics engine that:
analyzes said analytics database to create a report comprising click through information for said campaign information.

2. The system of claim 1, said tracking system that further:
detects when said campaign information is shared through said first social network by said first user;
creates a record comprising an identifier for said first person; and
stores said record in said analytics database.

3. The system of claim 1, said tracking system that:
receives information from said social media network when said first link is viewed by people connected to said first user.

4. The system of claim 3, said information from said social media network comprising how many users viewed said campaign information.

5. The system of claim 3, said information from said social media network comprising how many friends said first user has.

6. The system of claim 5, said information further comprising a demographic profile for at least one of said friends of said first user.

7. The system of claim 6, said campaign manager that further:
determines a target demographic for said campaign information;
said analytics engine that further:
determines a click through rate for said target demographic.

8. The system of claim 1, said campaign manager that further:
detects that at least a portion of said campaign information was used in a second social network as a second social network post by a second user; and
creates a third campaign information for said second social network post, said second campaign information having a second link, said third link causing said campaign manager to receive at least some communication.

9. The system of claim 8, said first social network and said second social networks being different social networks.

10. The system of claim 1, said first social network being a microblogging social network.

11. The system of claim 10, said first social network post being generated by clicking on a button on a website associated with said campaign information.

12. The system of claim 1, said first social network being a social network where said first user indicated an affinity for said campaign information.

13. The system of claim 12, said affinity causing said campaign information to be posted for friends of said first user to see.

14. A method performed on a computer processor, said method comprising:
creating an advertising campaign comprising links to an advertised website;
transmitting said links in an initial seeding operation to a plurality of users;
monitoring a first social network to determine a first posting comprising at least a portion of said advertising campaign, said first posting being performed by a first user;
determining a first number of impressions of said first posting;
determining a first number of actions performed by other users based on said first posting; and
determining an effective click through rate for said first posting based on said first number of impressions and said first number of actions.

15. The method of claim 14, said initial seeding comprising communicating other than using said social network.

16. The method of claim 14 further comprising:
monitoring a second social network to determine a second posting comprising at least a portion of said advertising campaign, said second posting being performed by a second user;
determining a second number of impressions of said second posting;
determining a second number of actions performed by other users based on said second posting; and
determining a social media effective click through rate for said advertising campaign based on said first number of impressions, said second number of impressions, said first number of actions, and said second number of actions.

17. The method of claim 16, said first social network being a two-way relationship-type social network and said second social network being a microblogging-type social network.

18. A social marketing platform comprising:
a campaign generator that:
creates links to a website, said website being a target website for a campaign; and
distributes said links to a plurality of users in a seeding operation;
a tracking system that:
monitors a plurality of social networks for posts that contain references to said website;
determines a number of impressions for said posts;
determines a demographic profile for each of said impressions; and
determines a number actions based on said posts;
an analytics system that:
determines an effective click through rate for said campaign based on a target demographic.

19. The social marketing platform of claim 18, said number of impressions being estimated number of impressions based on friend relationships to each user who created said references.

20. The social marketing platform of claim 18, at least some of said number of impressions being likely number of views, said likely number of views being provided by a first social network based on said posts.
